(19) United States
(12) Patent Application Publication
(10) Pub. No.: US 2003/0153326 A1
(43) Pub. Date: Aug. 14, 2003

(54) Arrangement and method for optimizing the traffic load in a telecommunication and/or data network

(76) Inventors: Stefan Jenzowsky, Berlin (DE); Frank Ryll, Berlin (DE)

Correspondence Address: Kevin R. Spivak, Morrison & Foerster LLP, Suite 300, 1650 Tysons Boulevard, McLean, VA, 22102, US

(21) Appl. No.: 10/335,263

(22) Filed: Jan. 2, 2003

(30) Foreign Application Priority Data
Jan. 3, 2002 (EP) 02000122.8

(51) Int. Cl. H04Q 7/20

(52) U.S. Cl. 455/453; 455/452

(57) ABSTRACT

Arrangement for optimizing the traffic load in a telecommunication and/or data network comprising a plurality of functionally essentially independent network elements, a plurality of content databases and/or platforms, which can be connected to the network elements, and a network operations control unit which exhibits an evaluation and decision unit for evaluating load messages.

The invention relates to an arrangement for optimizing the traffic load in a telecommunication or data network according to the preamble of claim 1 and to a corresponding operating procedure for such a network.

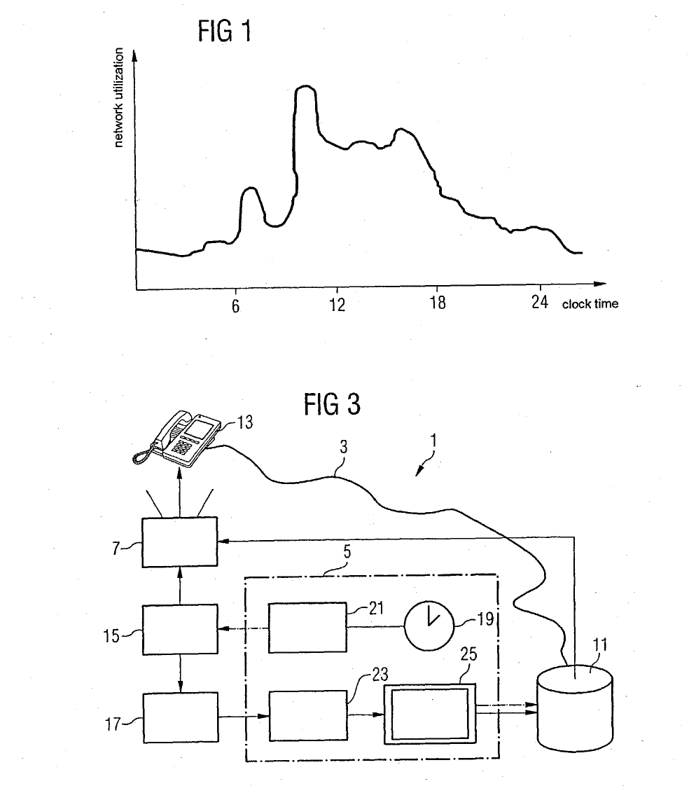

Conventional telecommunication or data networks, regardless of technology/methods (e.g. POTS, ISDN, Cable TV, Broadband Internet, GSM, PCS, PHS, CDMA, TDMA, UMTS; independently of channel-oriented or packet-oriented transmission) exhibit a utilization of their traffic capacity which fluctuates greatly in the course of a day. In the low-traffic times, sometimes more than 90% of the existing capacity is not used. FIG. 1 shows an example of a typical network utilization curve as a function of time.

This situation has previously only been remedied by non-technical (economical) means (e.g. tarrifing) which has relatively weak and nonselective effects or it is accepted as given. For this reason, special tariff structures with considerable differences in charges between high-traffic and low-traffic times have been offered for a long time both in the public switch telephone network (PSTN) and in the mobile radio networks. In any case, restructuring of the traffic volume can only be realized to a limited extent for normal telephony (i.e. voice links) due to the normal diurnal rhythms of most people—in the private domain—and in view of the normal working times. Special tariff structures of the Internet providers by means of which the utilization of the public switch telephone network is to be made attractive to the users as a data network at low-traffic times have only been addressed to a relatively small group of users and, therefore, only achieved limited success.

As the network resources of the telecommunication networks are to be used for supplementary services—partially associated with much higher bandwidth and other resource requirement—in addition to telephony, organizing a high utilization which is as uniform as possible becomes increasingly of importance. On the one hand, the network utilization at the peak periods limits the possible range of supplementary (particularly resource-intensive) services with respect to capacity and, on the other hand, the utilization of the expensive infrastructure, naturally, determines the price of the services offered via the telecommunication network to a considerable extent.

It can be expected that an optimization of the network utilization by means of the selective use of particular applications will be achieved in the next few years. These can be applications which have specific usage times (e.g. of erotica contents), are only accessible at particular times (e.g. horoscopes, diary applications) or utilize more advantageous tariffs at low-traffic times (e.g. sending faxes during the night). Like an economic optimization by means of cheaper utilization prices at low-traffic times (e.g. during the night), this type of optimization may well lead to the goal.

When the possibilities of this optimization of the network utilization by means of applications made selectively dependent on usage time, and special tariff structures, have been largely exhausted, there will be an increasing demand for technical solutions for increasing the mean network utilization.

In consequence, the invention is based on the object of providing an arrangement and a method of the generic type by means of which this demand can be met and a future-proof technical solution can be provided which makes a significant contribution to increasing the mean utilization of telecommunication or data networks.

In its device aspect, this object is achieved by an arrangement having the features of claim 1 and in its method aspect, it is achieved by a method having the features of claim 8.

A significant concept of the invention is that, in continuation of the measures of tariffs and offers already established or being introduced, in a further step, the triggering and controlling of applications of any type by means of the network utilization permit a much finer-grained optimization with greater dynamic range. The specified arrangement and the proposed method are suitable for faster and more precise control of the network utilization. Due to this faster and more precise form of optimization of the network utilization of telecommunication networks, higher network utilization coefficients can be achieved which, in turn, lead to an increased return on investment for the network operators. The proposed method is thus suitable for leading to a much higher return on investment in the operation of telecommunication networks and possibly lower service prices for the customers.

In the arrangement, the invention thus includes the implementation of technical means for monitoring the traffic load and transmitting units, connected to these, for transmitting corresponding load messages at the network elements to be monitored with regard to their utilization. However, modern network infrastructures already largely have such technical means. Furthermore, means for receiving the load messages from the network elements and an evaluation and decision unit for evaluating them and for carrying out predetermined control processes as a result of the evaluation must be implemented at the network operations control unit.

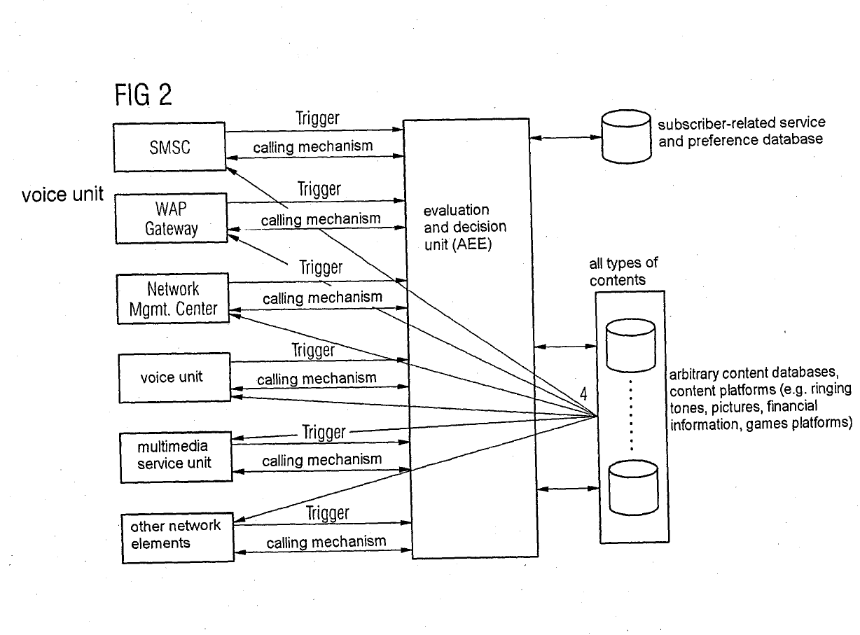

FIG. 2 shows in a basic diagram the solution according to the invention, represented in a greatly simplified telecommunication network structure. Due to the labeling, the figure is largely self explanatory so that in the text which follows, no closed description is given but only aspects worthy of being emphasized are noted.

All relevant network elements (e.g. SMSC, WAP gateway, multimedia service unit) and network management and control units (e.g. network management center (NMC)) either send traffic-dependent triggers (also called load messages in the text which follows) to the evaluation and decision unit AEE or are polled for the traffic status by the AEE.

Depending on the service-specific traffic load, the AEE, after having evaluated the service and subscriber databases, will send such control information to content databases or platforms which cause the latter to send information to the users of such services.

Essential aspects of the method and of the arrangement are:

single- or multi-stage triggers which are sent to the AEE by various network elements or network monitoring and control units,

interfaces at the network elements which allow the traffic status to be polled by the AEE,

the AEE which is connected to the network elements or network monitoring or control units and which is also connected

to various databases, e.g. subscriber and content databases or platforms in order to interrogate data from these devices and to send event-controlling information to them.

The AEE is controlled by service-specific algorithms which contain the clock time and, among other things, data from the abovementioned databases or from the platforms as input parameters. As a result of the assessment of these parameters, the AEE will send control information to the databases or platforms which cause the latter to send information to one or more service users (subscribers) in order to stimulate these for the further service utilization immediately following. Thus, in collaboration of the AEE with the content databases or platforms, the utilization of network elements with little loading is increased directly by selective content transmission to the users or indirectly via an activity increasing the traffic volume, which emanates from the users.

In a first important application of the proposed arrangement and of the corresponding method, the telecommunication or data network comprises a cellular mobile radio network, and at least one SMSC and/or one WAP gateway and/or one network management center and/or one voice unit and/or one multimedia service unit, as network elements, are monitored and controlled with regard to their utilization. An application of no less importance in perspective relates to fixed networks, particularly broadband, narrowband or telephony cable networks with the relevant network management center and/or voice unit and/or multimedia service unit and/or access points for telecommunication and data services network elements.

If all currently conceivable types of applications with the proposed solution are to be included in the context of an optimization of the network utilization in a largely universal solution, all constructive features described are necessary. However, the optimization can also be performed for only some applications (e.g. only for on-line games). This reduces the implementation expenditure since only these applications need to receive information from the evaluation and decision unit. If only a few network elements are to be included in the optimization, only these units will send triggers to the AEE.

The proposed method is clearly superior to the non-technical (economical) optimization of the network utilization with regard to

speed,

granularity of the control (smaller utilization gaps can be optimized),

adaptability (response to unpredicted events, fast fluctuations of the network load, partial failure of the telecommunication network),

inclusion of user data (e.g. initial utilization of the application versus later utilization),

return on investment for the network operator and the application provider.

It provides quasi-dynamic control, particularly increase in the traffic utilization of telecommunication networks.

Sending out the abovementioned information is possible at neutral cost for the operator(s) since the infrastructure required for this (network elements, control facilities etc.) is already in existence and, as a rule, is currently subject to uneconomically low usage.

Advantages and suitable applications of the invention can be obtained from the subclaims and the description below of a preferred exemplary embodiment of the arrangement and of exemplary applications and scenarios.

FIG. 3 shows in the manner of a functional block diagram essential components of a preferred embodiment of the optimization arrangement 1 according to the invention in a telecommunication network 3. The telecommunication network 3 has a central network operations control unit 5 which, among other things, is constructed for controlling as high as possible network utilization (and the operation of which is also described here only to this extent). In the example shown, the network operations control unit 5 communicates with a network element 7 in order to detect its traffic load, and a games database 11 in order to provide its contents to a user at a telecommunication terminal 13 at a data rate set in dependence on the network utilization. (In reality, a network structure in which the application of the invention is appropriate comprises a plurality of network elements in which a multiplicity of telecommunication terminals is connected and, in the normal case, also a plurality of content databases or platforms for providing information or communication resources to the telecommunication terminals).

The network element 7 is associated with a traffic load monitoring unit 15 for detecting the current traffic load, which, in turn, is connected to a load message transmitting unit 17 for transmitting a load message, containing the corresponding information, to the network operations control unit 5. The operation of the traffic load monitoring unit 15 is controlled from the network operations control unit 5 which, for this purpose, has a timer 19 and a trigger signal transmitting unit 21, connected to the former, for sending out a trigger signal in each case initiating a detection process.

In the network operations control unit, the load message passes to a load data receiving unit 23 and from this—in a suitably edited form—to an evaluation and decision unit 25. As the result of an evaluation, the latter generates, according to a predetermined algorithm, a control message which is transmitted to the games database 11 where it activates the sending out of a predetermined information message to the telecommunication terminal 13 via the network element 7. This information message itself or a communication process initiated by it and triggered by the user of the terminal 13 effects a suitable control of the network load at the network element 7 in dependence on its currently found load. In the text which follows, examples of such control processes are outlined.

In future, games, video, music and photos will be transmitted, e.g. in a UMTS network. The method described will make it possible for many of these applications to be

a) arranged (see example below),

b) activated (e.g. data delivery for a further games level),

c) adapted in the degree of difficulty or representation,

d) ended or restricted on the basis of the network utilization.

The following possibilities are obtained for games:

degree of difficulty is controlled by network utilization,

bonus games are controlled by network utilization,

actions in the games are controlled by network utilization (e.g. enemy attacks),

special characteristics are controlled by network utilization,

SMSs used for continuing the game are controlled by network utilization.

The following possibilities are obtained for SMSS:

invitations are sent out controlled by network utilization,

advertising is sent out controlled by network utilization,

invitations for playing games are controlled by network utilization.

The following possibilities are obtained for mobile commerce:

vouchers are sent out controlled by network utilization,

coupons are sent out controlled by network utilization.

The following, e.g., is obtained for information/infotainment:

horoscopes are sent out controlled by network utilization,

weather reports are sent out controlled by network utilization.

Sample Scenario 1:

Simulation game in the World Wide Web (WWW) which is controlled primarily by a WWW interface (Web browser) and secondarily by SMS (mobile part) by the user. The simulation game is running continuously in the WWW and can send and receive SMSs.

Callup by the end user: 9.45 pm Sunday, access via Web browser.

User starts the exploration of 3 strange planets from a space station.

Callup by the end user: 9.10 am Monday, access via Web browser.

User starts to settle 2 of the 3 strange planets. Callup by network load-dependent trigger (mobile radio network <20% network utilization for SMS): 11.45 am Monday, sending out of SMS by the application. SMS content: there is an earthquake on one of the planets.

Monday 11.49 am:

User sends out SMS/uses WAP access: initiate rescue work.

Callup by network load-dependent trigger (mobile radio network <20% network utilization for SMS): 1.55 pm Monday, sending out of SMS by the application. SMS content: there is another earthquake on one of the planets.

2.10 pm Monday:

User sends out SMS/uses WAP access: initiate evacuation of the planet.

Callup by end user: 9.45 pm Monday, access via web browser.

User resettles all persons to other planets and starts new planet exploration.

Sample Scenario 2:

Racing game, transmission via UMTS, task: controlling a racing car.

First callup by end user: 9.45 pm Sunday, 20% network utilization.

AEE sends corresponding triggers, stores utilization.

Setting: day. Resolution: high. Environment: viewers can be seen, animated, the hairs of the viewers are fluttering in the wind.

Second callup by the end user: 12.45 pm Wednesday, 80% network utilization.

AEE sends corresponding triggers, stores utilization.

Setting: fog. Resolution: low. Environment: only the track is visible, the rest is lost in the fog.

Third call-up by end user: 11.11 pm Wednesday, 10% network utilization. AEE sends corresponding triggers, stores utilization.

Setting: day. Resolution: very high. Environment: viewers, high resolution. In addition, bonus rounds are issued.

Fourth call-up by the end user: Thursday 3.55 pm, 90% network utilization.

AEE sends corresponding triggers, stores utilization.

Setting: night. Resolution: very low. Environment: only the light beams of the cars can be seen and the rest remains in night darkness.

The execution of the invention is not restricted to the examples described above and emphasized aspects but is similarly possible in a multiplicity of modifications which are within the scope of expert capability.

1. An arrangement (1) for optimizing the traffic load in a telecommunication and/or data network (3) comprising a plurality of functionally essentially independent network elements, a plurality of content databases (11) and/or platforms, which can be connected to the network elements (7), and a network operations control unit (5), characterized in that
at least some of the network elements are associated with traffic load monitoring units (15) and, connected to these, load message transmitting units (17) for transmitting load messages signaling the traffic load of the respective network element to the network operations control unit,
the network operations control unit (5) has
a load data receiving unit (23) for receiving the load messages of at least some of the network elements and
an evaluation and decision unit (25), the input side of which is connected to the load data receiving unit, for evaluating the load messages and for outputting control signals in dependence on the message content to selected content databases or platforms, and
the content databases (11) and/or platforms are constructed for sending out predetermined contents or other information to telecommunication or data terminals of users, connected to selected network elements, in response to the control signals.

2. The arrangement as claimed in claim 1, characterized in that the traffic load monitoring units (15) or the load message transmitting units (17) of the network elements (7) are associated with timers which activate a detection of the traffic load or the sending out of a load message to the network operations control unit at predetermined times or at predetermined time intervals.

3. The arrangement as claimed in claim 1, characterized in that the traffic load monitoring units (15) have discriminator units which continuously compare a detected traffic load with preprogrammed threshold values and activate the sending out of a load message when the load exceeds and/or drops below these threshold values.

4. The arrangement as claimed in claim 1, characterized in that the evaluation and decision unit (25) of the network operations control unit is associated with a timer (19) and a trigger pulse transmitter (21) connected to the latter, via which trigger pulses for calling load messages at the traffic load monitoring units (15) are generated and sent out.

5. A telecommunication and/or data network comprising an arrangement as claimed in claim 1, characterized in that the telecommunication and/or data network (5) exhibits a cellular mobile radio network and the network elements comprise at least one SMSC and/or one WAP gateway and/or one network management center and/or one voice unit and/or one multimedia service unit.

6. The telecommunication and/or data network comprising an arrangement as claimed in claim 1, characterized in that the telecommunication and/or data network (5) exhibits a public switch telephone network, particularly a broadband, narrowband or telephony cable network and the network elements comprise a network management center and/or a voice unit and/or a multimedia service unit and/or access points for telecommunication and data services.

7. The telecommunication and/or data network as claimed in claim 5, characterized by a subscriber database, particularly constructed as HLR, which is connected to the evaluation and decision unit via a controller, for storing subscriber profile data of the users which are connected or can be connected to the network elements.

8. The telecommunication and/or data network as claimed in claim 5, characterized in that the content databases (11) contain stored preprogrammed ringing tones, text modules of short messages, pictures, videos, items of music or the like in the form of retrievable files and/or, as contents platforms, a financial or investment platform and/or a games platform and/or a contact platform and/or shopping and/or an advertising platform are provided.

9. A method for optimizing the traffic load in a telecommunication and/or data network comprising a plurality of functionally essentially independent network elements, a plurality of content databases and/or platforms, which can be connected to the network elements, and a network operations control unit, characterized in that
the current traffic load is detected at the network elements,
in response to timer or external trigger signals or the result of a comparison with preprogrammed threshold values, load messages are generated for signaling the traffic load and are sent to the network operations control unit,
the load messages are received and evaluated at the network operations control unit and
in dependence on the message content of the evaluated load messages, control signals to selected content databases or platforms for sending out predetermined contents or other information to telecommunication or data terminals of users, connected to selected network elements, are generated.

10. The method as claimed in claim 9, characterized in that the network operations control unit sends out trigger signals to the network elements for generating or transmitting load messages.

11. The method as claimed in claim 9, characterized in that threshold values of the traffic load which are used for a comparison triggering the sending out of load messages are first programmed at the network elements.

12. The method as claimed in claim 9, characterized in that control signals are output to selected content databases or platforms in dependence on prestored profile data of the users.
